(19) United States
(12) Patent Application Publication
(10) Pub. No.: US 2009/0048763 A1
(43) Pub. Date: Feb. 19, 2009

(54) Control Apparatus and Control Method of an Internal Combustion Engine

(76) Inventors: Takashi Nishikiori, Shizuoka-ken (JP); Shuichi Ezaki, Shizuoka-ken (JP); Akio Kidooka, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/223,786

(22) PCT Filed: Feb. 7, 2007
(86) PCT No.: PCT/IB2007/000287

§ 371 Date: Aug. 8, 2008

(30) Foreign Application Priority Data
Feb. 10, 2006 (JP) 2006-034002

(51) Int. Cl. F02D 45/00

(52) U.S. Cl. 701/103; 123/198 F; 123/332

(57) ABSTRACT

During a fuel cut, a recommended reactivated cylinder and a reactivatable cylinder are determined based on the stopped positions of an intake valve and an exhaust valve (step 104). A fastest reactivatable cylinder is then determined based on the crank angle, from among the recommended reactivated cylinder and the reactivatable cylinder (step 108). Also, the rotating direction of a motor when a variable valve drive apparatus starts to be driven again when the fastest reactivatable cylinder is made the reactivated cylinder is also determined. When a reactivation command is output, operation resumes from the fastest reactivatable cylinder when the situation calls for rapid reactivation (step 124). When the situation does not call for rapid reactivation, operation resumes from the recommended reactivated cylinder (step 118).

### BACKGROUND OF THE INVENTION

1. Field of the Invention

The invention relates to a control apparatus and control method of an internal combustion engine. More particularly, the invention relates to a control apparatus and control method of an internal combustion engine, which controls the internal combustion engine to stop driving intake and exhaust valves during a fuel cut.

2. Description of the Related Art

Japanese Patent Application Publication No. JP-A-2004-143990, for example, describes a related control apparatus of an internal combustion engine provided with a valve driving mechanism that can halt an opening operation of intake and exhaust valves. This related control apparatus keeps either the intake valves or the exhaust valves or both closed in a plurality of cylinders during a fuel cut by halting an opening operation of those valves to prevent an exhaust gas control catalyst from degrading due to fresh air flowing into the exhaust passage during a fuel cut.

According to the related art, either the intake valves or the exhaust valves or both are kept closed during a fuel cut so fresh air can be prevented from flowing into the exhaust passage. However, when operation resumes after a fuel cut, the intake and/or exhaust valves are driven again. If at this time the intake and/or exhaust valves start to be driven again at a timing to which no particular thought had been given, there is a possibility that fresh air may flow into the exhaust passage. In order to reliably suppress degradation of the catalyst, it is desirable that as little fresh air as possible be allowed to flow into the exhaust passage even when the cylinder resumes operation. Thus in this respect there still remains room for improvement in the related technology described above.

### SUMMARY OF THE INVENTION

This invention thus provides a control apparatus and control method of an internal combustion engine, which can effectively suppress degradation of a catalyst both while a fuel cut is being performed and when operation is resumed after a fuel cut (in this specification, resuming operation refers to a cylinder starting to function in the normal manner again with the restart of fuel injection after a fuel cut).

A first aspect of the invention relates to a control apparatus of an internal combustion engine including a variable valve driving apparatus which selectively drives and stops an intake valve and an exhaust valve of the internal combustion engine which has a plurality of cylinders, fuel cutting means for performing a fuel cut in the internal combustion engine when a fuel cut executing condition is satisfied, and valve stopping means for stopping the variable valve driving apparatus such that at least one of the intake valve and the exhaust valve in each cylinder remains closed during the fuel cut. This control apparatus includes reactivated cylinder determining means for determining, based on at least one of a stopping position of the variable valve driving apparatus and a crank angle, a reactivated cylinder in which fuel injection is to be restarted first when resuming operation after a fuel cut; valve drive restarting means for starting to drive the variable valve driving apparatus again when operation is resumed after a fuel cut such that burned gas remaining in the determined reactivated cylinder is discharged into an exhaust passage before the first intake stroke is performed in the reactivated cylinder after operation is resumed; and fuel injection restarting means for restarting fuel injection in the reactivated cylinder such that fresh air that was drawn into the reactivated cylinder during the first intake stroke after the reactivated cylinder resumes operation can be combusted. In this specification, the term “reactivate” and its derivative forms refers to a cylinder resuming operation after a fuel cut. Similarly, the term “deactivate” and its derivative forms refer to a fuel cut being executed in a cylinder.

According to the first aspect, at least one of the intake valve and the exhaust valve in each cylinder can be kept closed during a fuel cut so a situation can be avoided in which fresh air flows into the exhaust gas control catalyst. As a result, degradation of the catalyst can be effectively suppressed. Also according to the first aspect, the reactivated cylinder in which fuel injection is first restarted when operation is resumed after a fuel cut can be determined based on at least one of the stopping position of the variable valve drive apparatus and the crank angle. Further, driving of the variable valve drive apparatus can be restarted such that burned gas remaining in the reactivated cylinder is discharged to the exhaust passage before the first intake stroke is performed in the reactivated cylinder after operation is resumed. As a result, poor combustion due to residual burned gas can be suppressed and combustion immediately after reactivation can be stabilized. Moreover, according to the first aspect, fuel injection can be restarted in the reactivated cylinder such that fresh air that was drawn into the reactivated cylinder during the first intake stroke after the reactivated cylinder resumes operation can be combusted. Therefore, the fresh air that was drawn into the reactivated cylinder during the first intake stroke after reactivation can be sent to the exhaust passage after being combusted. As a result, it is possible to suppress fresh air from flowing to the catalyst even when resuming operation. Accordingly, degradation of the catalyst can be suppressed.

Also, according to a second aspect of the invention, in the first aspect, the reactivated cylinder determining means includes recommended reactivated cylinder determining means for determining a recommended reactivated cylinder based on the stopping position of the variable valve driving apparatus during the fuel cut.

According to the second aspect, the recommended reactivated cylinder can be determined based on the stopping position of the variable valve drive apparatus during a fuel cut. Accordingly, the optimum reactivated cylinder can be selected to resume operation without sending fresh air to the catalyst.

Also, according to a third aspect of the invention, in the first aspect, the variable valve driving apparatus has at least one electric motor that rotatably drives a camshaft, and the reactivated cylinder determining means includes recommended reactivated cylinder determining means for determining, as a recommended reactivated cylinder, a cylinder in which an intake stroke is performed first based on the stopping position of the camshaft under the condition that the electric motor rotates only in the forward direction when the valves of the cylinders start to be driven again when operation is resumed after a fuel cut.

According to the third aspect, the cylinder in which the first intake stroke after reactivation can be performed without operating in reverse the electric motor that rotates the camshaft of the variable valve drive apparatus can be set as the recommended reactivated cylinder. Resuming operation after a fuel cut with the recommended reactivated cylinder as the reactivated cylinder avoids placing a load on the electric motor.

Also, according to a fourth aspect of the invention, in the first aspect, the variable valve driving apparatus has at least one electric motor that rotatably drives a camshaft, and the reactivated cylinder determining means includes i) recommended reactivated cylinder determining means for determining, as a recommended reactivated cylinder, a cylinder in which an intake stroke is performed first based on the stopping position of the camshaft under the condition that the electric motor rotates only in the forward direction when the valves of the cylinders start to be driven again when operation is resumed after a fuel cut, ii) reactivatable cylinder determining means for determining, as a reactivatable cylinder, a cylinder in which an intake stroke is performed first based on the stopping position of the camshaft when the electric motor is allowed to rotate in reverse when the valves in the cylinders start to be driven again when operation is resumed after a fuel cut, and iii) final determining means for determining one cylinder, from among the recommended reactivated cylinder and the reactivatable cylinder, to be the reactivated cylinder.

According to the fourth aspect, a recommended reactivated cylinder in which the first intake stroke after reactivation can be performed without operating in reverse the electric motor that rotates the camshaft of the variable valve drive apparatus is determined, as is a reactivatable cylinder in which the first intake stroke after reactivation can be performed when reverse rotation of the electric motor is allowed, and one of the recommended reactivated cylinder and the reactivatable cylinder can be ultimately set as the reactivated cylinder. Therefore, the optimum reactivated cylinder can be determined according to the situation when resuming operation after a fuel cut.

Also, according to a fifth aspect of the invention, in the fourth aspect, the final determining means determines the reactivated cylinder giving priority to the recommended reactivated cylinder over the reactivatable cylinder.

According to the fifth aspect, the reactivated cylinder can be determined giving priority to the recommended reactivated cylinder over the reactivatable cylinder. Therefore, the frequency with which the electric motor of the variable valve drive apparatus is operated in reverse can be reduced, thus reducing the load placed on the motor.

Also, according to a sixth aspect of the invention, in the fifth aspect, the final determining means determines a cylinder in which combustion can be restarted first based on the crank angle, from among the recommended reactivated cylinder and the reactivatable cylinder, to be the reactivated cylinder in a predetermined situation in which operation should be resumed quickly after a fuel cut, and determines the recommended reactivated cylinder to be the reactivated cylinder regardless of the crank angle in a situation other than the predetermined situation.

According to the sixth aspect, in a situation where operation should be resumed quickly, the cylinder in which combustion can be performed again first based on the crank angle, from among the recommended reactivated cylinder and the reactivatable cylinder, is made the reactivated cylinder. In any other situation, the recommended reactivated cylinder can be made the reactivated cylinder regardless of the crank angle. Therefore, when the situation calls for operation to be resumed quickly, operation can be resumed quickly without delay. Also, in a situation that does not call for reactivation to be performed quickly, reverse rotation of the electric motor of the variable valve drive apparatus can be avoided, thus minimizing the load placed on the electric motor.

Also, according to a seventh aspect of the invention, in the sixth aspect, the predetermined situation includes at least one of a situation in which a decrease in engine speed is equal to or greater than a predetermined value in the case of natural reactivation which is brought about by the engine speed being equal to or less than a predetermined reactivation speed, and a situation in which the degree of acceleration required is equal to or greater than a predetermined value in the case of forced reactivation which is brought about by a request for acceleration being output.

According to the seventh aspect, when the engine speed drops quickly in the case of natural reactivation, or when the degree of acceleration required is high in the case of forced reactivation, operation can be resumed quickly without delay after a fuel cut.

Also, according to an eighth aspect of the invention, the control apparatus in any one of the fourth to seventh aspects also includes fastest reactivatable cylinder determining means for determining a fastest reactivatable cylinder in which combustion can restart first based on the crank angle, from among the recommended reactivated cylinder and the reactivatable cylinder, and rotating direction determining means for determining the direction of rotation when the motor starts to be driven again when operation is resumed after a fuel cut with the fastest reactivatable cylinder as the reactivated cylinder.

According to the eighth aspect, the fastest reactivatable cylinder in which combustion can be performed again first based on the crank angle is selected from among the recommended reactivated cylinder and the reactivatable cylinder. In addition, the rotating direction of the electric motor when it starts to be driven again can be determined when operation is resumed after a fuel cut with the fastest reactivatable cylinder as the reactivated cylinder. Therefore, when rapid reactivation is performed, a delay in resuming operation after a fuel cut can be suppressed so reactivation can be performed smoothly and quickly.

Also, according to a ninth aspect of the invention, the control apparatus in any one of the first to eighth aspects also includes valve overlap shortening means for shortening, compared to normal, a period of valve overlap during which the exhaust valve and the intake valve of the same cylinder are both open when operation resumes after a fuel cut.

According to the ninth aspect, when operation resumes after a fuel cut, the period of valve overlap can be shortened. Therefore, a backflow of burned gas in the cylinder and exhaust passage into the intake passage immediately after operation resumes can be suppressed. As a result, that burned gas will not flow back into the cylinder so poor combustion and misfiring can be suppressed even immediately after operation resumes at which time combustion tends to be unstable.

Also, according to a tenth aspect of the invention, in the ninth aspect, the valve overlap shortening means cancels the shortening of the period of valve overlap when ignition timing control, which is executed to correct torque, ends after operation resumes after a fuel cut.

According to the tenth aspect, valve overlap period shortening control after operation resumes can be cancelled at the optimum timing when combustion has sufficiently stabilized.

Also, according to an eleventh aspect of the invention, in any one of the first to tenth aspects, the fastest reactivatable cylinder determining means repeatedly determines the fastest reactivatable cylinder in which combustion can restart first based on the crank angle during one rotation of a crankshaft, and the reactivated cylinder determining means includes the fastest reactivatable cylinder determining means, as well as means for setting the cylinder that is determined by the fastest reactivatable cylinder determining means to be the fastest reactivatable cylinder at the time a reactivation command is output as the reactivated cylinder.

According to the eleventh aspect, during a fuel cut, the fastest reactivatable cylinder which continuously changes depending on the crank angle can be determined in advance based on the crank angle before a reactivation command is output. Then when a reactivation command is output, the fastest reactivatable cylinder at that point can be set as the reactivated cylinder. As a result, operation can be resumed immediately without delay.

Also, according to a twelfth aspect of the invention, in any one of the first to eleventh aspects, during the fuel cut the valve stopping means stops driving the variable valve driving apparatus such that the intake valve in each cylinder remains closed and no fresh air remains in any cylinders.

According to the twelfth aspect, during a fuel cut, it is possible to have the intake valve of each cylinder be closed and no fresh air remaining in any of the cylinders. Therefore, fresh air that had remained in the cylinders during a fuel cut could not flow out to the catalyst when operation is resumed so fresh air can be suppressed from being sent to the catalyst even when operation is resumed, thus further suppressing degradation of the catalyst.

Also, according to a thirteenth aspect of the invention, in any one of the first to twelfth aspects, during the fuel cut the valve stopping means stops driving the variable valve driving apparatus such that, by having the intake valves remain closed and the exhaust valves remain open in at least a pair of cylinders having pistons which always travel in opposite directions, burned gas passes between the pair of cylinders through the exhaust passage.

According to the thirteenth aspect, during a fuel cut, gas exchange in which burned gas flows through the exhaust passage between a pair of cylinders is made possible. In the cylinders between which gas exchange is performed, burned gas is allowed to enter and exit freely which also suppresses fresh air from leaking slightly from the intake valve. Therefore, the amount of air flowing to the catalyst during a fuel cut can be made especially small, thereby further suppressing degradation of the catalyst.

Also, according to a fourteenth aspect of the invention, in any one of the first to thirteenth aspects, the reactivated cylinder determining means determines one cylinder, from among the cylinders in which the exhaust valve remains open during the fuel cut, to be the reactivated cylinder.

According to the fourteenth aspect, one cylinder from among the cylinders in which the exhaust valve is kept open during a fuel cut can be set as the reactivated cylinder. When operation is resumed, burned gas inside the reactivated cylinder needs to be discharged into the exhaust passage before the intake stroke is performed in the reactivated cylinder. Therefore, making the cylinder in which the exhaust valve is already open the reactivated cylinder enables the burned gas to be discharged rapidly prior to the intake stroke. As a result, operation is able to be resumed smoothly and quickly without delay after a fuel cut.

A fifteenth aspect of the invention relates to a control method of an internal combustion engine that includes a variable valve driving apparatus which selectively drives and stops an intake valve and an exhaust valve of the internal combustion engine which has a plurality of cylinders, fuel cutting means for performing a fuel cut in the internal combustion engine when a fuel cut executing condition is satisfied, and valve stopping means for stopping the variable valve driving apparatus such that at least one of the intake valve and the exhaust valve in each cylinder remains closed during the fuel cut. This control method includes the steps of: determining, based on at least one of a stopping position of the variable valve driving apparatus and a crank angle, a reactivated cylinder in which fuel injection is to be restarted first when resuming operation after a fuel cut; starting to drive the variable valve driving apparatus again such that burned gas remaining in the determined reactivated cylinder is discharged into an exhaust passage before the first intake stroke is performed in the reactivated cylinder after operation is resumed; and restarting fuel injection in the reactivated cylinder such that fresh air that was drawn into the reactivated cylinder during the first intake stroke after the reactivated cylinder resumes operation can be combusted.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view of the structure of a system according to an example embodiment of the invention;

FIG. 2 is a perspective view of the structure of a variable intake valve driving apparatus;

FIG. 3 is a view of an intake camshaft as viewed from the axial direction;

FIG. 4 is a perspective view of the structure of a variable exhaust valve driving apparatus;

FIG. 5 is a view of an exhaust camshaft as viewed from the axial direction;

FIG. 6 is a graph showing the relationship between rotation angle of the exhaust camshaft and lift of the exhaust valves in each cylinder;

FIG. 7 is a chart illustrating control that stops operation of the intake and exhaust valves in each cylinder at the start of a fuel cut;

FIG. 8 is a view illustrating a state of the engine in which the intake valves of all of the cylinders are kept closed based on the control that stops operation of the valves shown in FIG. 7;

FIG. 9A is a view illustrating a state of the engine in which the exhaust valves of the #1 and #2 cylinders are kept closed and the exhaust valves of the #3 and #4 cylinders are kept open (i.e., partially open) based on the control that stops operation of the valves shown in FIG. 7;

FIG. 9B is a view of the exhaust camshaft, as viewed from the axial direction, in the state shown in FIG. 9A;

FIG. 10 is a chart illustrating control that starts fuel injection and valve operation again when resuming operation after a fuel cut with the #3 cylinder as the reactivated cylinder;

FIG. 11 is a chart illustrating control that starts fuel injection and valve operation again when resuming operation after a fuel cut with the #4 cylinder as the reactivated cylinder;

FIG. 12 is a chart showing the cylinder that is to be the reactivated cylinder when rapid reactivation is performed; and

FIG. 13 is a flowchart of a routine executed in the example embodiment of the invention.

### DETAILED DESCRIPTION OF THE PREFERRED EMBODIMENTS

### System Structure

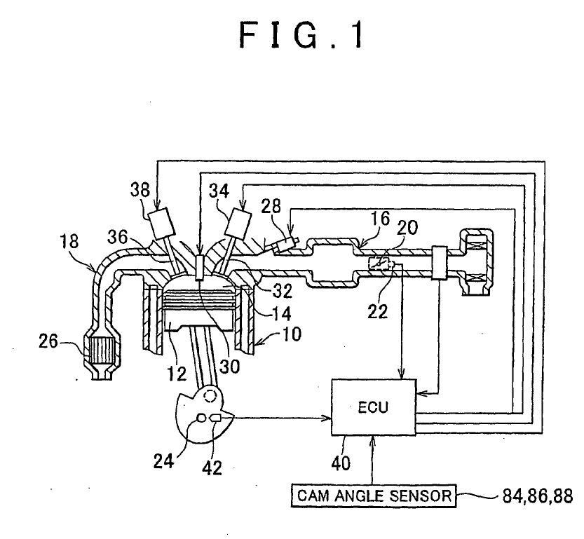

FIG. 1 is a view of the structure of a system according to an example embodiment of the invention. The structure shown in the drawing includes an internal combustion engine 10. The internal combustion engine 10 here is an inline four cylinder internal combustion engine. A piston 12 is provided in each cylinder of the internal combustion engine 10 and an intake passage 16 and an exhaust passage 18 are connected to a combustion chamber 14 of each cylinder.

A throttle valve 20 is provided in the intake passage 16. A throttle position sensor 22 which detects a throttle opening amount TA is arranged near the throttle valve 20. Also, a catalyst 26 that purifies exhaust gas is arranged in the exhaust passage 18.

A fuel injection valve 28 that injects fuel into an intake port, and a spark plug 30 that ignites the air-fuel mixture in the combustion chamber 14 are provided for each cylinder of the internal combustion engine 10. Furthermore, the internal combustion engine 10 includes a variable intake valve driving apparatus 34 that drives an intake valve 32 and a variable exhaust valve driving apparatus 38 that drives an exhaust valve 36. A crank angle sensor 42 for detecting rotation angle (crank angle) and rotation speed (engine speed NE) of a crankshaft 24 is provided near the crankshaft 24 of the internal combustion engine 10.

The system shown in FIG. 1 includes an ECU (Electronic Control Unit) 40. This ECU 40 is connected to various sensors such as the throttle position sensor 22 and the crank angle sensor 42 described above, as well as to various actuators of the fuel injection valve 38, the spark plug 30, the intake variable valve driving apparatus 34, and the variable exhaust valve driving apparatus 38, for example.

Also, in the system of this example embodiment, cam angle sensors 84, 86, and 88 are also provided which detect the rotation angles of intake camshafts 52 and 54, and an exhaust camshaft 76, respectively, which will be described late. The ECU 40 is also connected to these cam angle sensor 84, 86, and 88.

[Structure of the Variable Valve Driving Apparatuses]

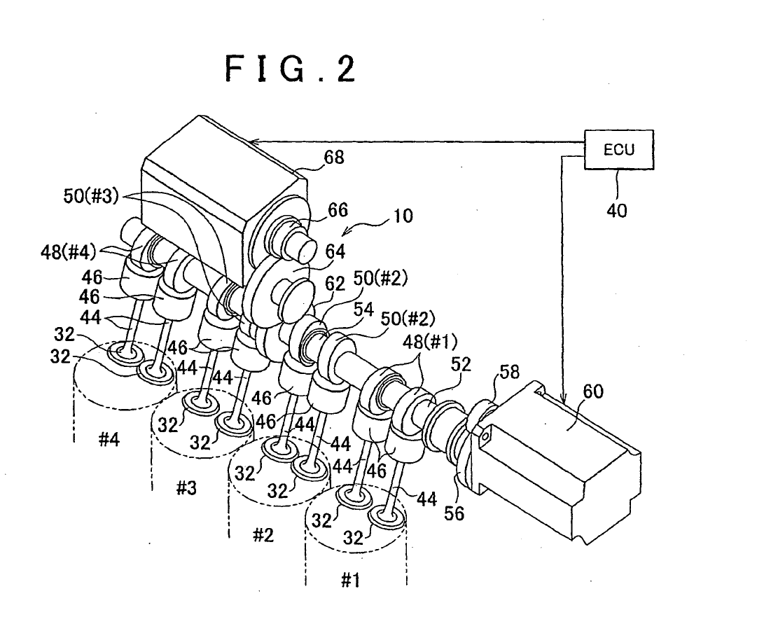

Hereinafter, the structures of the variable intake valve driving apparatus 34 and the variable exhaust valve driving apparatus 38 according to the example embodiment of the invention will be described with reference to FIGS. 2 to 5.

FIG. 2 is a perspective view of the structure of the variable intake valve driving apparatus 34 shown in FIG. 1. The variable intake valve driving apparatus 34 shown in FIG. 2 is an apparatus used to drive the intake valves 32 of the internal combustion engine 10. In FIG. 2, reference numerals #1, #2, #3, and #4 denote a first, a second, a third, and a fourth cylinder, respectively, of the internal combustion engine 10. The firing order in the internal combustion engine 10 is the same as it is in a typical internal combustion engine, i.e., #1→#3→#4→#2.

As shown in FIG. 2, two intake valves 32 are provided for each cylinder of the internal combustion engine 10. A valve stem 44 is fixed to each intake valve 32 and a valve lifter 46 is mounted to the upper end portion of each valve stem 44. Urging force from a valve spring, not shown, is applied to each valve stems 44, which urges each intake valve 32 closed.

A corresponding intake cam 48 or intake cam 50 is arranged above each of the valve lifters 46. As shown in FIG. 2, here, the intake cams corresponding to the valve lifters 46 that are arranged in the #1 and #4 cylinders will be referred to as intake cams 48, and the intake cams corresponding to the valve lifters 46 that are arranged in the #2 and #3 cylinders will be referred to as intake cams 50. The intake cams 48 that correspond to the #1 and #4 cylinders are fixed to the intake cams shaft 52. The intake cams 50 that correspond to the #2 and #3 cylinders are fixed to the intake camshaft 54 which is arranged on the same axis as the intake camshaft 52 but is able to rotate independently from the intake camshaft 52. That is, with the structure shown in FIG. 2, a common camshaft is used for cylinders in which the firing timing differs by 360° CA. According to this kind of structure, these intake camshafts, i.e., the intake camshaft 52 corresponding to the #1 and #4 cylinders and the intake camshaft 54 corresponding to the #2 and #3 cylinders can rotate or slide in the circumferential direction independently from one another. The intake camshaft 52 and the intake cam shaft 54 are rotatably supported by a support member such as a cylinder head, not shown.

A first driven gear 56 is fixed to the one intake camshaft 52, on the same axis as the one intake camshaft 52. A first output gear 58 is in mesh with this first driven gear 56. The first output gear 58 is fixed to an output shaft of a first motor 60, on the same axis as that output shaft.

Operation of the first motor 60 is controlled by the ECU 40. The first motor 60 is able to rotate in both forward and reverse directions. During normal operation, the first motor 60 is driven in the forward direction such that driving force from the motor is transmitted to the intake camshaft 52 via the first driven gear 56 and the first output gear 58, thus rotating the intake camshaft 52 in the forward direction. As a result, the intake valves 32 of the #1 and #4 cylinders can be driven open and closed. The opening and closing timings of the intake valves 32 of the #1 and #4 cylinders can be controlled as appropriate by controlling the rotation amount and rotation speed of the first motor 60 based on the crank angle.

A second driven gear 62 is fixed to the other intake camshaft 54, on the same axis as the other intake camshaft 54. A second output gear 66 is in mesh via an intermediate gear 64 with the second driven gear 62. The second output gear 66 is fixed to an output shaft of a second motor 68, on the same axis as that output shaft.

Operation of the second motor 68 is also controlled by the ECU 40. The second motor 68 is able to rotate in both forward and reverse directions. During normal operation, the second motor 68 is driven in the forward direction such that driving force from the motor is transmitted to the intake camshaft 54 via the second driven gear 62, the intermediate gear 64, and the second output gear 66, thus rotating the intake camshaft 54 in the forward direction. As a result, the intake valves 32 of the #2 and #3 cylinders can be driven open and closed. The opening and closing timings of the intake valves 32 of the #2 and #3 cylinders can be controlled as appropriate by controlling the rotation amount and rotation speed of the second motor 68 based on the crank angle.

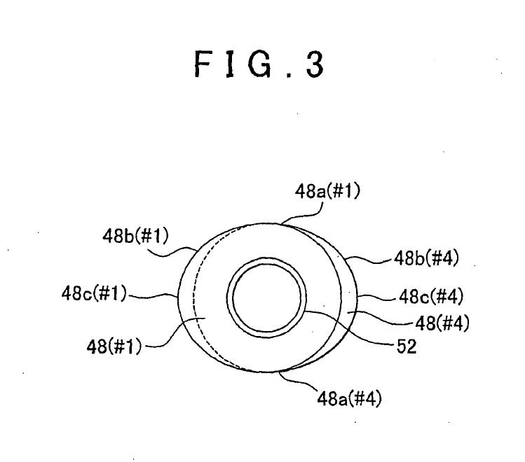

FIG. 3 is a view of the detailed structure of the intake cams 48 shown in FIG. 2 when the intake camshaft 52 is viewed from the axial direction. As described above, the intake cams 48 (#1) and the intake cams 48 (#4) are fixed to the intake camshaft 52. As shown in FIG. 3, each of the intake cams 48 (#1) for the #1 cylinder has two intake cam faces, i.e., a non-working face 48a (#1) and a working face 48b (#1), which have different profiles. The non-working face 48a (#1) (i.e., a circular base portion) is formed such that the distance from the center of the intake camshaft 52 is constant. The working face 48b (#1) on the other hand is formed such that the distance from the center of the intake camshaft 52 gradually increases closer to an apex portion 48c (#1) and then gradually decreases past the apex portion 48c (#1). Also, each of the intake cams 48 (#4) of the #4 cylinder also has a non-working face 48a (#4) and a working face 48b (#4) similar to the intake cam 48 (#1). The apex portion 48c (#1) of the intake cam 48 (#1) and the apex portion 48c (#4) of the intake cams 48 (#4) are arranged offset from one another by 180° in the circumferential direction of the intake camshaft 52.

This kind of intake camshaft 52 enables both the intake cams 48 of the #1 cylinder and the intake cams 48 of the #4 cylinder to contact the valve lifters 46 with the non-working faces 48a (#1). Stopping the intake camshaft 52 by stopping the first motor 60 in this state keeps the intake valves 32 of the #1 and #4 cylinders from opening, i.e., keeps the intake valves 32 of the #1 and #4 cylinders closed.

Although not shown, the relationship between the intake cams 50 for the #2 and #3 cylinders on the intake shaft 54 is similar to that described above. Therefore, the intake valves 32 of the #2 and #3 cylinders can be kept from opening, i.e., kept closed, by appropriately controlling the angle at which the rotation of the second motor 68 is stopped.

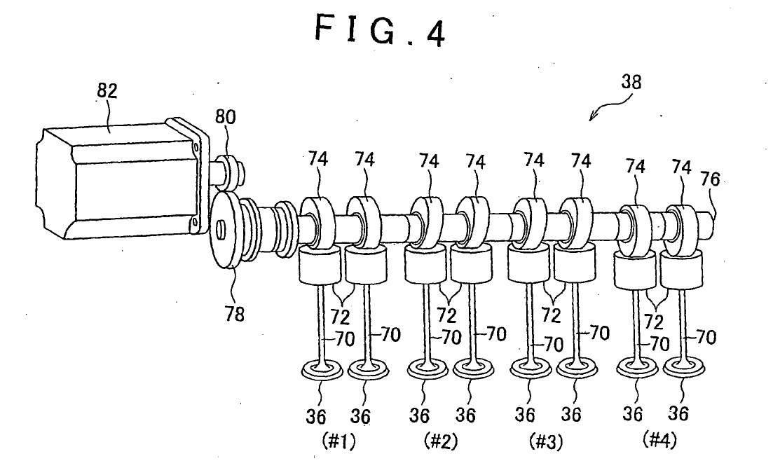

Next, FIG. 4 is a perspective view of the structure of the variable exhaust valve driving apparatus 38 shown in FIG. 1. The variable exhaust valve driving apparatus 38 shown in FIG. 4 is an apparatus used to drive the exhaust valves 36 of the internal combustion engine 10. As shown in FIG. 4, there are two exhaust valves 36 provided for each cylinder of the internal combustion engine 10. A valve stem 70 is fixed to each exhaust valve 36 and a valve lifter 72 is mounted to the upper end portion of each valve stem 70. Urging force from a valve spring, not shown, is applied to each valve stem 70, which urges each exhaust valve 36 closed.

An exhaust cam 74 is provided above each valve lifter 72. As shown in FIG. 4, on the exhaust side, all of the exhaust cams 74 are fixed to a single exhaust camshaft 76 at different predetermined mounting angles for each cylinder. A driven gear 78 is fixed to one end of the exhaust camshaft 76, on the same axis as the exhaust camshaft 76, and an output gear 80 is in mesh with this driven gear 78. The output gear 80 is fixed to an output shaft of the motor 82, on the same axis as that output shaft.

Operation of the first motor 82 is controlled by the ECU 40. During normal operation, the motor 82 is driven in the forward direction such that driving force from the motor is transmitted to the exhaust camshaft 76 via the driven gear 78 and the output gear 80, thus rotating the exhaust camshaft 76 in the forward direction. As a result, the exhaust valves 36 of the #1 and #4 cylinders can be driven open and closed. The opening and closing timings of the intake valves 36 of the #1 and #4 cylinders can be controlled as appropriate by controlling the rotation amount and rotation speed of the motor 82 based on the crank angle.

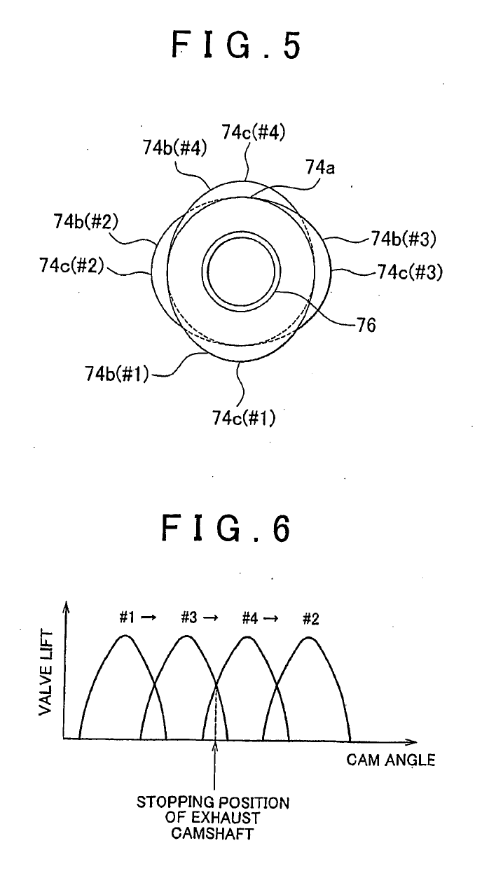

FIG. 5 is a view of the detailed structure of the exhaust camshaft 76 shown in FIG. 4 when viewing the exhaust camshaft 76 from the axial direction. As described above, exhaust cams 74 of each cylinder #1 to #4 are fixed to the exhaust camshaft 76. As shown in FIG. 5, each of the exhaust cams 74 has a non-working face 74a (a circular base portion) and a working face 74b (#1 to #4), similar to the intake cams 48 and the like. Apex portions 74c (#1 to #4) corresponding to the cylinders are arranged offset at 90° intervals in the circumferential direction of the exhaust camshaft 76 to match the firing order in the internal combustion engine 10, i.e., #1→#3→#4→#2.

FIG. 6 is a graph showing the relationship between the rotation angle of the exhaust camshaft 76 and the lift of the exhaust cam 36 of each cylinder. As shown in FIG. 6, with the exhaust camshaft 76, there is overlap in which the exhaust valves 36 of cylinders have adjacent firing orders are open (i.e., partially open) at the same time. Therefore, when rotation of the exhaust camshaft 76 is stopped at the position indicated by the arrow in FIG. 6, for example, the exhaust valves 36 of the #3 and #4 cylinders can both be kept open.

### Characteristics of the Example Embodiment

In the system of this example embodiment, a routine to stop the injection of fuel, i.e., execute a fuel cut (F/C), is performed when a predetermined condition to execute a fuel cut, such as when the vehicle is decelerating, is satisfied. When a fuel cut is executed in a related internal combustion engine system, air (fresh air) flows into the exhaust passage 18 and into the catalyst 26. The catalyst 26 is prone to degradation when exposed to oxygen in a high temperature environment. Therefore, in order to suppress degradation of the catalyst 26, the system according to this example embodiment suppresses the flow of fresh air containing oxygen into the exhaust passage 18 by stopping the intake valves 32 and exhaust valves 36 from opening while a fuel cut is being executed.

Also, in this example embodiment, at the start of a fuel cut or when restarting the supply of fuel after a fuel cut (in this specification, restarting the supply of fuel after a fuel cut may also be referred to as “resuming operation” or “reactivation”), the amount of oxygen that flows into the catalyst 26 can be kept extremely low by controlling the variable intake valve driving apparatus 34 and the variable exhaust valve driving apparatus 38 in the manner described below. As a result, degradation of the catalyst 26 can be suppressed.

(Control to Stop Driving Valves at the Start of a Fuel Cut)

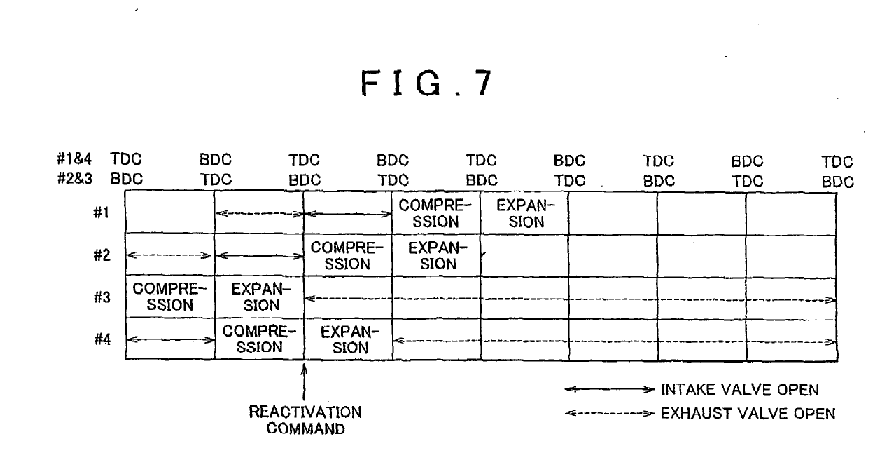

FIG. 7 is a chart illustrating control to stop operation of the intake valves 32 and exhaust valves 36 in each cylinder at the start of a fuel cut. In the drawing, the horizontal axis represents the crank angle. Solid lines with arrows at both ends indicate that the intake valves 32 are open, and broken lines with arrows on both ends indicate that the exhaust valves 36 are open. These arrows are only general indicators and do not take valve overlap and the like into account.

In the internal combustion engine 10, the phases of both the #1 and #4 cylinders are off by 360° CA from one another so one of the cylinders reaches top dead center (TDC) while the other simultaneously reaches bottom dead center (BDC). Similarly, the phases of both the #2 and #3 cylinders are also off by 360° CA from one another so one of the cylinders reaches TDC while the other simultaneously reaches BDC.

Here, as shown in FIG. 7, a case will be described in which a command to initiate a fuel cut (hereinafter referred to as “deactivation command”) has been output when the #1 cylinder is at the end of the exhaust stroke (i.e., exhaust TDC). In the #1 cylinder, the intake stroke is performed immediately after the deactivation command has been output Operation of the first motor 60 that drives the intake camshaft 52 is stopped after opening and closing the intake valves 32 as usual with an intake stroke of the #1 cylinder. Then while the fuel cut is being executed, the intake valves 32 of both the #1 and #4 cylinders are kept closed.

The air-fuel mixture drawn into the #1 cylinder during the intake stroke of that cylinder is ignited and combusted during the compression stroke, and then expanded during the power stroke (i.e., the expansion stroke). As will be described later, the motor 82 that drives the exhaust camshaft 76 is already stopped at this time so the exhaust valves 36 of the #1 cylinder do not open thereafter and remain closed during the fuel cut as well. Therefore, in the #1 cylinder, the burned gas is kept trapped inside the cylinder during the fuel cut.

When the deactivation command is output, the #2 cylinder at the end of the intake stroke (i.e., intake BDC). After the intake valves 32 of the #2 cylinder are closed following the end of the intake stroke, operation of the second motor 68 that drives the intake camshaft 54 is stopped. Thereafter, the intake valves 32 of both the #2 and #3 cylinders are kept closed during the fuel cut.

At the time the deactivation command is output, the air-fuel mixture drawn into the #2 cylinder is ignited and combusted during the compression stroke, and then expanded during the expansion stroke. The exhaust camshaft 76 is already stopped at this time so the exhaust valves 36 of the #2 cylinder do not open thereafter and remain closed during the fuel cut as well. Therefore, in the #2 cylinder, the burned gas is kept trapped inside the cylinder during the fuel cut just as it is in the #1 cylinder.

When the deactivation command is output, the #3 cylinder is at the end of the power stroke (i.e., the expansion stroke). At this time, the exhaust valves 36 of the #3 cylinder are beginning to open. Then the motor 82 that drives the exhaust camshaft 76 is stopped while the exhaust valves 36 are in the middle of closing following the end of the exhaust stroke. More specifically, the motor 82 is stopped when the rotation angle of the exhaust camshaft 76 is in the position indicated by the arrow in FIG. 6, i.e., in the position where the exhaust valves 36 of both the #3 and #4 cylinders are partially open. Thereafter, the exhaust valves 36 of both the #3 and #4 cylinders are kept open during the fuel cut.

When the deactivation command is output, the #4 cylinder is at the end of the compression stroke (i.e., compression TDC). The air-fuel mixture in the #4 cylinder at this time is ignited and combusted, and then expanded in the expansion stroke. In the latter half of this expansion stroke, the exhaust valves 36 of the #4 cylinder start to open, and when they are partially open, the exhaust camshaft 76 is stopped as described above. Thereafter, the exhaust valves 36 of the #4 cylinder are kept open.

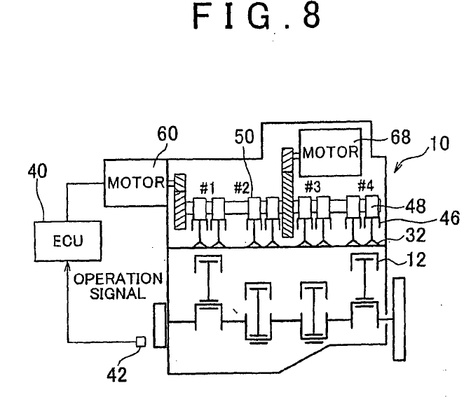

FIG. 8 is a view illustrating a state of the engine in which the intake valves of all of the cylinders are kept closed based on the control that stops operation of the valves that was described above. The variable intake valve driving apparatus 34 of this example embodiment enables the intake valves 32 of all of the cylinders to be kept closed by the ECU stopping the first motor 60 and the second motor 68 in states where the circular base portions of the intake cams 48 and 50 are contacting the valve lifters 46. As a result, fresh air can be prevented from being introduced into the cylinders during a fuel cut, thereby suppressing the catalyst 26 from being exposed to fresh air.

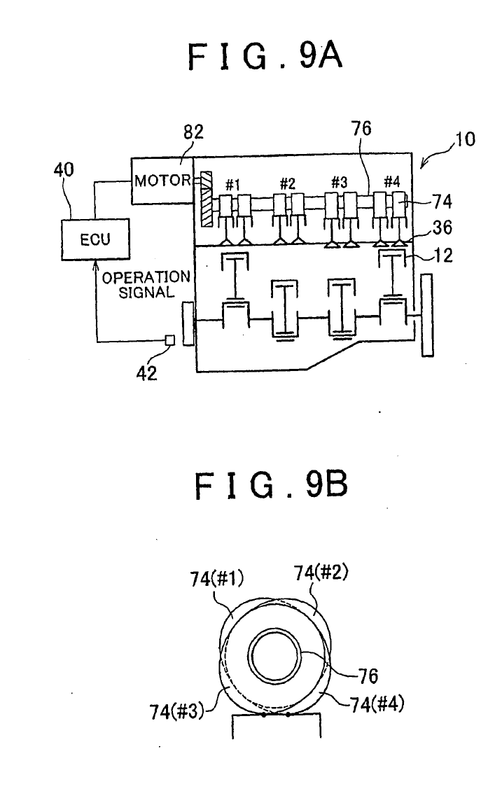

FIG. 9A is a view illustrating a state of the internal combustion engine 10 in which the exhaust valves of the #1 and #2 cylinders are kept closed and the exhaust valves of the #3 and #4 cylinders are kept open (i.e., partially open) based on the control that stops operation of the valves that was described above. FIG. 9B is a view of the exhaust camshaft 76, as viewed from the axial direction, in the state shown in FIG. 9A.

In the internal combustion engine 10, the firing order is #1→#3→#4→#2 so the pistons 12 in the #1 and #4 cylinders and the pistons 12 in the #2 and #3 cylinders move up and down with a phase difference of 180° CA. That is, the piston 12 in the #3 cylinder and the piston 12 in the #4 cylinder always travel in different directions. During a fuel cut, the exhaust valves 36 of the #3 and #4 cylinders are both open. Therefore when the piston 12 in the #3 cylinder rises and the piston 12 in the #4 cylinder descends, burned gas that was discharged from the #3 cylinder is drawn into the #4 cylinder through the exhaust manifold (i.e., the exhaust passage 18). Conversely, when the piston 12 in the #4 cylinder rises and the piston 12 in the #3 cylinder descends, the burned gas that was discharged from the #4 cylinder is drawn into the #3 cylinder through the exhaust manifold. In this way, during a fuel cut, burned gas passes back and forth between the #3 cylinder and the #4 cylinder via the exhaust manifold. This phenomenon will hereinafter be referred to as “gas exchange”.

When gas exchange is not performed, there is still some leakage due to the increase and decrease in in-cylinder pressure that occurs as the piston 12 moves, even if the intake valves 32 are closed. Therefore, some air, albeit a very small amount, still flows to the exhaust passage 18 during a fuel cut. In contrast, in cylinders in which gas exchange is performed, the slight leakage from the intake valves 32 is able to be suppressed by having the burned gas enter and exit the cylinders freely. As a result, the amount of air that flows to the exhaust passage 18 can be further reduced. Thus, in this example embodiment, perforating gas exchange during a fuel cut further reduces the amount of oxygen that flows to the catalyst 26, thus better suppressing degradation of the catalyst 26.

In the above description, a case was described in which gas exchange is performed between the #3 cylinder and the #4 cylinder. However, the cylinders between which gas exchange is performed is not limited to these. As long as gas exchange is performed between cylinders in which gases flowing to the exhaust passage 18 flow in opposite directions, it may be performed between any pair of cylinders. For example, gas exchange may be performed between the #1 cylinder and the #4 cylinder or between the #2 cylinder and the #4 cylinder. The pair of cylinders between which gas exchange is performed may also be changed according to the timing at which the deactivation command is output.

Here, the stopping positions of the intake camshafts 52 and 54 when control to stop operation the valves is performed in the pattern shown in FIG. 7 described above are checked. The intake camshaft 52 for the #1 and #4 cylinders is stopped after the intake valves 32 of the #1 cylinder have closed. Therefore, when the first motor 60 starts to operate again in the forward direction, the intake valves 32 of the #4 cylinder are the first to open. On the other hand, the intake camshaft 54 for the #2 and #3 cylinders is stopped after the intake valves 32 of the #2 cylinder have closed. Therefore, when the second motor 68 starts to operate again in the forward direction, the intake valves 32 of the #3 cylinder are the first to open.

When operation resumes after a fuel cut in the manner described above, it is first necessary to determine the cylinder in which the fuel injection should first be performed and the intake valves 32 and exhaust valves 36 should first be driven. Hereinafter, the cylinder in which the fuel injection is to be performed first after a fuel cut will be referred to as the “reactivated cylinder”. In order to minimize the possibility of degradation of the catalyst 26, the following must be kept in mind when determining which cylinder is to be the reactivated cylinder.

(1) In order to minimize the possibility of degradation of the catalyst 26, it is preferable that, to the greatest extent possible, unburned air (i.e., fresh air) not be sent to the exhaust passage 18 even when resuming operation after a fuel cut. Therefore, if fresh air is drawn into the cylinder when the intake valves 32 start to be driven again, it is desirable to always combust that the fresh air. In order to combust fresh air that is drawn into a cylinder in a port injection type internal combustion engine 10 such as the one in this example embodiment, fuel must be supplied into the cylinder together with that fresh air. In order to supply fuel into the cylinder, it is possible to inject fuel from the fuel injection valve 28 midway through the intake stroke, but from the viewpoint of promoting fuel atomization and the like, it is normally necessary to inject fuel into the intake port during the exhaust stroke before the intake valves 32 open. That is, fuel must be injected in advance into the intake port of that cylinder during the exhaust stroke before the intake valves 32 open when they start to be driven again.

(2) Typically, combustion tends to be unstable immediately after operation is resumed following a fuel cut. In the case of this example embodiment, there is burned gas remaining in each cylinder during a fuel cut as described above if burned gas in the cylinder flows out to the intake port (i.e., the intake passage 16) when the intake valves 32 start to be driven again, that burned gas will flow into the cylinder again on the intake stroke. If this happens, the percentage of burned gas in the air-fuel ratio would increase which would adversely affect combustion, and in the worst case, lead to a misfire. In order to avoid this, burned gas in the cylinder must be discharged to the exhaust passage 18 to the greatest extent possible before the first intake stroke after a fuel cut has ended.

(3) When the valves are stopped in the pattern shown in FIG. 7 and the first motor 60 and the second motor 68 start to operate again in the forward direction when operation resumes after a fuel cut, the intake valves 32 of the #4 cylinder or the #3 cylinder are the first to open, as described above. Therefore, if the first motor 60 and the second motor 68 are only operated in the forward direction, the cylinder that can be selected as the reactivated cylinder is naturally limited. On the other hand, if when operation resumes the first motor 60 and the second motor 68 are operated in reverse, the intake valves 32 of the #1 cylinder or the #2 cylinder can also be opened first. However, from the viewpoint of reducing the load on the first motor 60 and the second motor 68, it is preferable that the motors not be driven in reverse often.

Therefore, if the first motor 60 and the second motor 68 are only rotated in the forward direction, the intake valves 32 that will open first are those of the #4 cylinder or the #3 cylinder so the reactivated cylinder has to be one of those two cylinders. If the #4 cylinder were the reactivated cylinder, then based on the firing order the next cylinder to perform an intake stroke would be the #2 cylinder. However, in order for the intake valves 32 of the #2 cylinder to open in first, the second motor 68 must be operated in reverse. Therefore, the #4 can not be the reactivated cylinder. On the other hand, if the #3 cylinder were the reactivated cylinder, then the next cylinder to perform an intake stroke would be the #4 cylinder so the intake valves 32 of the #4 cylinder can be opened by forward operation of the first motor 60.

In this way, when the valves are stopped in the pattern shown in FIG. 7, the cylinder in which the intake stroke is performed first by the first motor 60, the second motor 68, and the motor 82 operating only in the forward direction when the variable valve driving apparatuses 34 and 38 are driven again is the #3 cylinder. In this example embodiment, the cylinder in which the intake stroke is performed first by the motors 60, 68, and 82 operating only in the forward direction when the variable valve driving apparatuses 34 and 38 are driven again will be referred to as the “recommended reactivated cylinder”. That is, when the valves are stopped in the pattern shown in FIG. 7, the #3 cylinder is the recommended reactivated cylinder. However, if the valves are stopped in a pattern other than the pattern shown in FIG. 7, another cylinder may be the recommended reactivated cylinder.

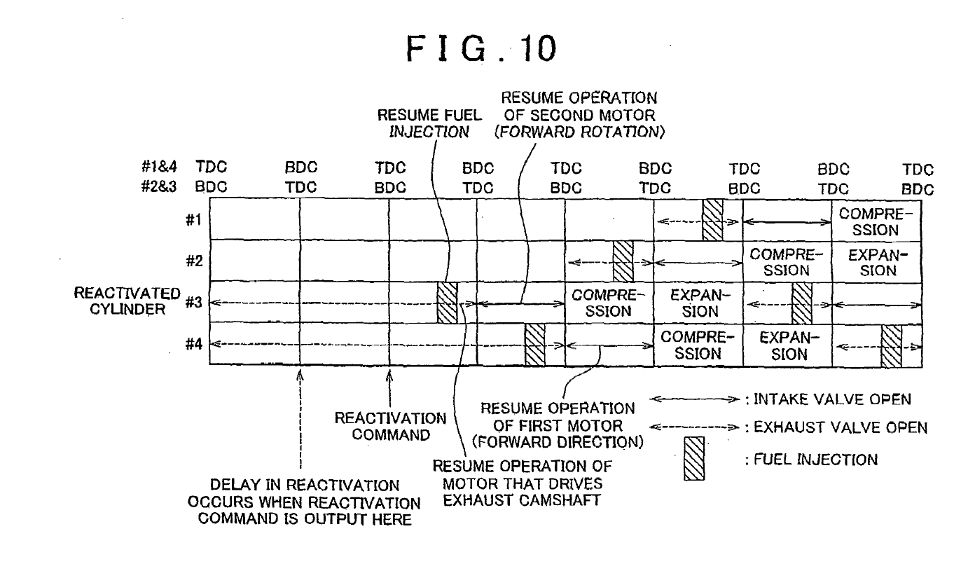

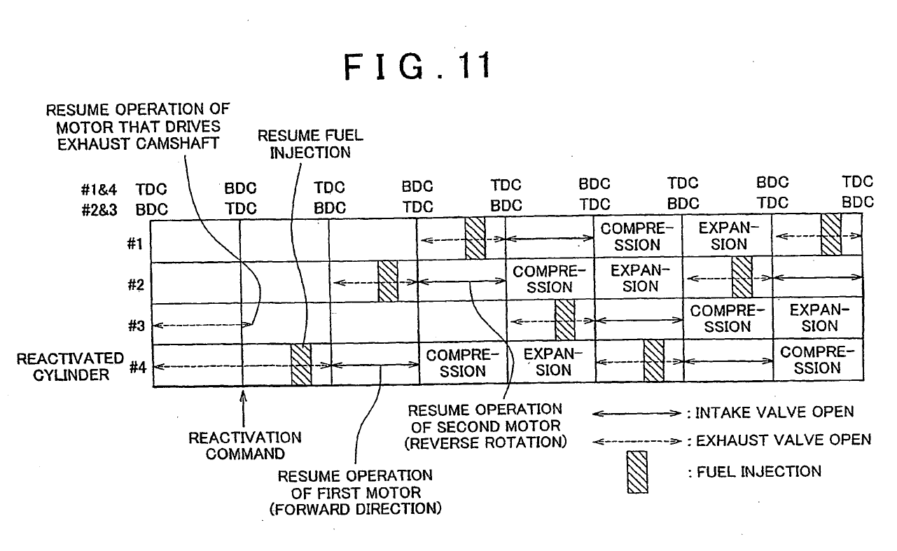

Hereinafter, control to start performing a fuel injection and driving the valves again when resuming operation after a fuel cut with the #3 cylinder, which is the recommended reactivated cylinder, as the reactivated cylinder will be described with reference to FIG. 10. In FIG. 10 and FIG. 11 (FIG. 11 will be described later), the horizontal axis represents the crank angle, the solid lines with arrows at both ends indicate that the intake valves 32 are open, and the broken lines with arrows at both ends indicate that the exhaust valves 36 are open, just as in FIG. 7. Also, the portions with hatching indicate fuel injection being performed.

Here, as shown in FIG. 10, a command to resume operation after a fuel cut (hereinafter referred to as “reactivation command”) is output when the #1 and #4 cylinders are at TDC and the #2 and #3 cylinders are at BDC. Immediately after this reactivation command is output, the piston 12 in the #3 cylinder rises such that burned gas in the #3 cylinder is discharged into the exhaust passage 18. That is, the #3 cylinder performs an exhaust stroke. During this exhaust stroke of the #3 cylinder, the fuel injection for the #3 cylinder is started again. That is, fuel is injected into the intake port from the fuel injection valve 28 of the #3 cylinder.

Also, during the last stage of the exhaust stroke of the #3 cylinder, the motor 82 that drives the exhaust camshaft 76 starts to operate again such that the exhaust valves 36 of the #3 cylinder close. Accordingly, the second motor 68 starts to operate again in the forward direction such that the intake valves 32 of the #3 cylinder open. As a result, the #3 cylinder performs the first intake stroke after resuming operation. At this time, fuel is already being injected into the intake port of the #3 cylinder so the air-fuel mixture that includes this fuel can be drawn into the #3 cylinder. Therefore, in this case the gas that was drawn into the #3 cylinder can be sent to the exhaust passage 18 after being combusted. Accordingly, fresh air will not be sent to the catalyst 26 so degradation of the catalyst 26 can be suppressed.

When the intake stroke is first performed in the #3 cylinder after resuming operation, an exhaust stroke is performed in the #4 cylinder. During this exhaust stroke, burned gas that was gas exchanged between the #3 cylinder and the #4 cylinder during the fuel cut is discharged from the #4 cylinder to the exhaust passage 18. Therefore, fresh air will not be sent to the catalyst 26 so degradation of the catalyst 26 can be suppressed. Also, during this exhaust stroke, fuel is injected inside the intake port from the fuel injection valve 28 of the #4 cylinder. Following the end of the exhaust stroke, the exhaust valves 36 of the #4 cylinder close and the first motor 60 is operated in the forward direction again such that the intake valves 32 of the #4 cylinder open. As a result, the #4 cylinder performs the first intake stroke after resuming operation and the air-fuel mixture that includes the fuel is drawn into the cylinder. Here, the gas that is drawn into the #4 cylinder is sent to the exhaust passage 18 after being combusted. Therefore, fresh air is not sent to the catalyst 26, thus enabling degradation of the catalyst 26 to be suppressed.

Hereinafter, fuel injection is performed and the exhaust valves 36 and intake valves 32 are driven again in the following order for the #2 cylinder and the #1 cylinder as well according to the firing order. When the exhaust stroke is first performed after operation resumes in the #2 and #1 cylinders, the burned gas that was trapped in those cylinders during the fuel cut is discharged to the exhaust passage 18. Also, gas that was drawn in on the first intake stroke after operation has resumed in the #2 and #1 cylinders is sent to the exhaust passage 18 after being combusted. In this way, fresh air is not sent from the #2 and #1 catalysts to the catalyst 26 so degradation of the catalyst 26 can be suppressed.

Also, in this example embodiment, as described above, when the exhaust valves 36 and the intake valves 32 of each cylinder start to be driven again, the timing at which the exhaust valves 36 close is earlier than normal and the timing at which the intake valves 32 opens is later than normal. As a result, the valve overlap period during which the exhaust valves 36 and the intake valves 32 are both open is shorter than normal (this shortened period also includes no overlap at all). Therefore, backflow of burned gas in the cylinder and in the exhaust passage 18 to the intake passage 16 can be suppressed. As a result, the burned gas will no longer flow into the cylinder again so poor combustion and misfiring after operation resumes can be suppressed.

As described with reference to FIG. 10 above, fresh air can be prevented from entering the catalyst 26 when operation resumes by resuming operation with the reactivated cylinder being the recommended reactivated cylinder (i.e., the #3 cylinder in this case). As a result, degradation of the catalyst 26 can be suppressed. Also, it is not necessary to operate the first motor 60, the second motor 68, or the motor 82 of the variable valve driving apparatuses 34 and 38 in reverse so the load that would otherwise be placed on these motors by operating them in reverse can be avoided.

When the reactivation command is output at the timing indicated by the solid arrow in FIG. 10, operation is resumed without delay, and thus quickly, by having the #3 cylinder, which is the recommended reactivated cylinder, be the reactivated cylinder.

In contrast, depending on the timing at which the reactivation command is output, operation may be resumed after a delay if the #3 cylinder is the reactivated cylinder. For example, there may be a case in which the reactivation command is output at the timing indicated by the broken arrow in FIG. 10, i.e., when the #1 and #4 cylinders are at BDC and the #2 and #3 cylinders are at TDC. In this case, the #3 cylinder is at TDC when that command is output so an intake stroke can be performed in the #3 cylinder if the motor 82 and the second motor 68 are driven again at this point such that the exhaust valves 36 of the #3 cylinder close and the intake valves 32 of the #3 cylinder open. However, if air is drawn in at this time, air which does not contain fuel is drawn into the #3 cylinder so that air is not able to be combusted and ends up being discharged as fresh air to the exhaust passage 18. Therefore, from the viewpoint of suppressing degradation of the catalyst 26, air should not be drawn into the #3 cylinder at this timing. Accordingly, even if a reactivation command is output at the timing shown by the broken arrow, it is necessary to wait until the crank angle proceeds 360° CA and draw air into the #3 cylinder at a timing that is the same as that when the reactivation command is output at the timing indicated by the solid arrow.

In this way, when the reactivation command is output at the timing indicated by the broken arrow in FIG. 10, the timing at which operation is resumed is the same as it is when the reactivation command is output at the timing indicated by the solid arrow, regardless of the fact that the reactivation command is output 180° CA earlier than the timing indicated by the solid arrow. That is, operation is resumed after a delay of approximately 180° CA.

When the reactivation command is output at the timing indicated by the broken arrow in FIG. 10, operation can be resumed without delay by having the #4 cylinder be the reactivated cylinder instead of the #3 cylinder which is the recommended reactivated cylinder. The #4 cylinder is able to be made the reactivated cylinder by operating the second motor 68 in reverse when it starts to be driven again. Hereinafter, control to resume fuel injection and start driving the valves again when resuming operation after a fuel cut with the #4 cylinder as the reactivated cylinder will be described with reference to FIG. 11.

In FIG. 11, the reactivation command is output when the #1 and #4 cylinders are at BDC and the #2 and #3 cylinders are at TDC. That is, the reactivation command is output at the same timing as is indicated by the broken arrow in FIG. 10. In this case, when the reactivation command is output, the motor 82 that drives the exhaust camshaft 76 first starts to operate again in the forward direction. As a result, the exhaust valves 36 of the #3 cylinder close so that only the exhaust valves 36 of the #4 cylinder are open. At this time, the piston 12 in the #4 cylinder rises such that an exhaust stroke is performed in the #4 cylinder. During this exhaust stroke, burned gas that was gas exchanged between the #3 cylinder and the #4 cylinder during the fuel cut is discharged from the #4 cylinder to the exhaust passage 18. Therefore, fresh air is not sent to the catalyst 26 so degradation of the catalyst 26 can be suppressed. Further, fuel injection in the #4 cylinder is resumed during the exhaust stroke of the #4 cylinder. That is, fuel is injected into the intake port from the fuel injection valve 28 of the #4 cylinder.

After the exhaust valves 36 of the #4 cylinder close following the end of the exhaust stroke of that cylinder, the first motor 60 starts to operate again in the forward direction such that the intake valves 32 of the #4 cylinder open. As a result, the #4 cylinder performs the first intake stroke after operation resumes. At this time, fuel is already being injected into the intake port of the #4 cylinder so an air-fuel mixture containing fuel can be drawn into the #4 cylinder. Accordingly, the gas drawn into the #4 cylinder can be sent to the exhaust passage 18 after being combusted. Therefore, fresh air is not sent to the catalyst 26 so degradation of the catalyst 26 can be suppressed.

When the #4 cylinder performs the first intake stroke after operation resumes, an exhaust stroke is performed in the #2 cylinder. In this exhaust stroke, the burned gas that was trapped in the cylinder during the fuel cut is discharged to the exhaust passage 18. Therefore, fresh air is not sent to the catalyst 26 so degradation of the catalyst 26 can be suppressed.

Also, during the exhaust stroke of the #2 cylinder, fuel is injected into the intake port from the fuel injection valve 28 of the #2 cylinder. Following the end of this exhaust stroke, the exhaust valves 36 of the #2 cylinder close and the second motor 68 starts to operate again in reverse. This reverse operation of the second motor 68 rotates the intake camshaft 54 in reverse a predetermined angle thereby opening the intake valves 32 of the #2 cylinder. As a result, the #2 cylinder performs the first intake stroke after operation resumes such that an air-fuel mixture containing fuel is drawn into the cylinder. During this intake stroke, the direction in which the second motor 68 is operating reverses to the forward direction such that following the end of this intake stroke the intake valves 32 of the #2 cylinder close. Thereafter, the second motor 68 continues to operate in the forward direction. In this way, here, by first having the second motor 68 start to operate in reverse, the intake valves 32 of the #2 cylinder, not the #3 cylinder, can be opened first. The gas drawn into the #2 cylinder during its first intake stroke after operation resumes is sent to the exhaust passage 18 after being combusted. Therefore, fresh air is not sent to the catalyst 26 so degradation of the catalyst 26 can be suppressed.

Hereinafter the exhaust valves 36 and the intake valves 32 start to be driven again and fuel injection resumes in order for the #1 and #3 cylinders as well according to the firing order. No fresh air is sent to the catalyst 26 from the #1 and #3 cylinders either so degradation of the catalyst 26 can be suppressed.

Even in a case in which operation is resumed starting with the #4 cylinder by the method shown in FIG. 11, when the exhaust valves 36 and the intake valves 32 of each cylinder start to be driven again, the timing at which the exhaust valves 36 close is earlier than normal and the timing at which the intake valves 32 open is later than normal, just as in the case shown in FIG. 10. Accordingly, the period of valve overlap in which both the exhaust valves 36 and the intake valves 32 are open at the same time can be shorter than normal, which suppresses the backflow of burned gas in the cylinder and in the exhaust passage 18 into the intake passage 16. As a result, that burned gas will not flow into the cylinder again so poor combustion and misfiring after operation resumes can be suppressed.

As was described with reference to FIG. 11 above, if the second motor 68 is operated in reverse when it starts to operate again, operation can be resumed after a fuel cut with the #4 cylinder, not the #3 cylinder, as the reactivated cylinder. Then when the reactivation command is output when the #1 and #4 cylinders are at BDC and the #2 and #3 cylinders are at TDC, operation is able to be resumed without delay by making the #4 cylinder be the reactivated cylinder. Also, even if the #4 cylinder is the reactivated cylinder, fresh air will not be sent to the catalyst 26 when operation is resumed so degradation of the catalyst 26 can be suppressed just as it is when the #3 cylinder is the reactivated cylinder.

Hereinafter in this specification, a cylinder in which the first intake stroke will be performed when the first motor 60 or the second motor 68 is allowed to operate in reverse when the variable intake valve driving apparatus 34 is driven again will be referred to as “reactivatable cylinder”. That is, in the foregoing example, the #4 cylinder is the reactivatable cylinder. However, if the valves are stopped in a pattern other than the pattern shown in FIG. 7, another cylinder may be the reactivatable cylinder. There may also be a plurality of reactivatable cylinders.

Operation of the cylinders resumes after a fuel cut in one of two ways; either by natural reactivation or by forced reactivation. Natural reactivation is when the cylinders resume operation when the engine speed NE drops to a predetermined reactivation speed (such as 1100 rpm) following a decrease in vehicle speed. Forced reactivation is when the cylinders resume operation when the driver is requiring acceleration, i.e., when the driver is depressing the accelerator pedal.

With natural reactivation, when the drop in the engine speed NE is rapid, it is preferable that operation be resumed as quickly as possible from the viewpoint of reliably avoiding engine stall. Also, with forced reactivation, when the accelerator pedal is depressed rapidly, it can be determined that the driver is requiring sudden acceleration, it is preferable that operation be resumed as quickly as possible. In these cases, it is preferable that a delay in resuming operation, even a delay of approximately 180° CA such as that as described above, not occur. On the other hand, if that is not the case, i.e., operation need not be resumed rapidly, a delay of approximately 180° CA in resuming operation does not pose a problem.

In view of this, with this example embodiment, when there is no need to resume operation rapidly, the recommended reactivated cylinder (in this case the #3 cylinder) is always made the reactivated cylinder regardless of the crank angle. When operation is resumed starting with the recommended reactivated cylinder, there is no need to operate the first motor 60 and the second motor 68 of the variable intake valve driving apparatus 34 in reverse, so the load that would be placed on these motors due to operating them in reverse can be avoided.

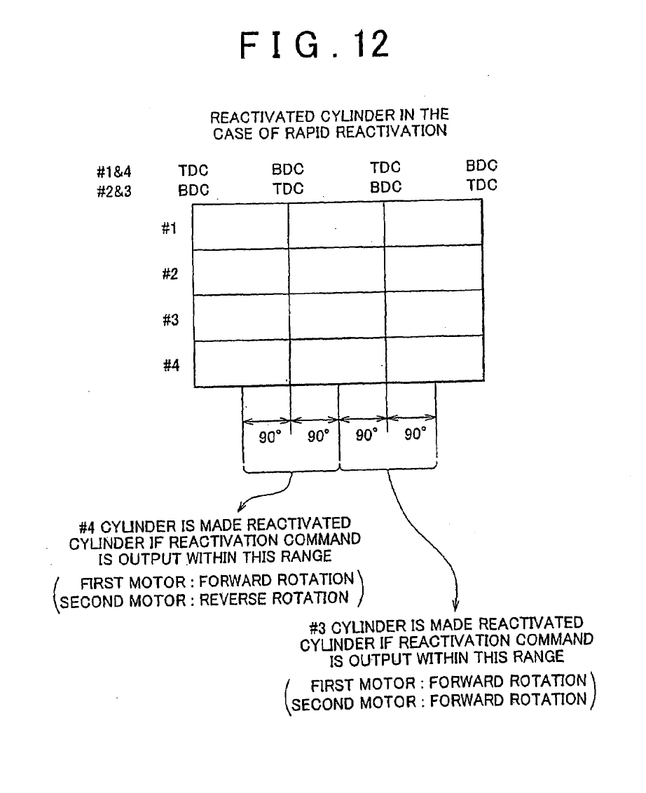

On the other hand, when the situation calls for operation to be resumed quickly, the cylinder in which combustion can take place the fastest is selected as the reactivated cylinder from among the recommended reactivated cylinder (in this case the #3 cylinder) and the reactivatable cylinder (in this case the #4 cylinder) based on the crank angle when the reactivation command was output. An example with the valve stopping pattern described above will now be described in more detail with reference to FIG. 12. When a reactivation command in output when the crank angle is in a range 90° CA before and after TDC of the #1 and #4 cylinders, and 90° CA before and after BDC of the #2 and #3 cylinders, reactivation starting with the #3 cylinder will allow for combustion to begin again the fastest, as shown in FIG. 10. Therefore in this case, the #3 cylinder is made the reactivated cylinder, as shown in FIG. 12. In contrast, when a reactivation command in output when the crank angle is in a range 90° CA before and after BDC of the #1 and #4 cylinders, and 90° CA before and after TDC of the #2 and #3 cylinders, reactivation starting with the #4 cylinder will allow for combustion to begin again the fastest, as shown in FIG. 11. Therefore in this case, the #4 cylinder is made the reactivated cylinder, as shown in FIG. 12. This kind of control will be referred to hereinafter as “rapid reactivation”.

In this way according to this example embodiment, when the situation calls for operation to be resumed quickly, rapid reactivation is performed such that operation can be resumed without delay regardless of the timing at which the reactivation command is output. Also, when operation does not need to be resumed quickly, priority is given to the recommended reactivated cylinder over the reactivatable cylinder so that the recommended reactivated cylinder becomes the reactivated cylinder, which reduces the frequency with which the first motor 60 and the second motor 68 of the variable intake valve driving apparatus 34 are driven in reverse. As a result, the load that would be placed on these motors due to operating them in reverse can be reduced.

### Specific Routine of the Example Embodiment

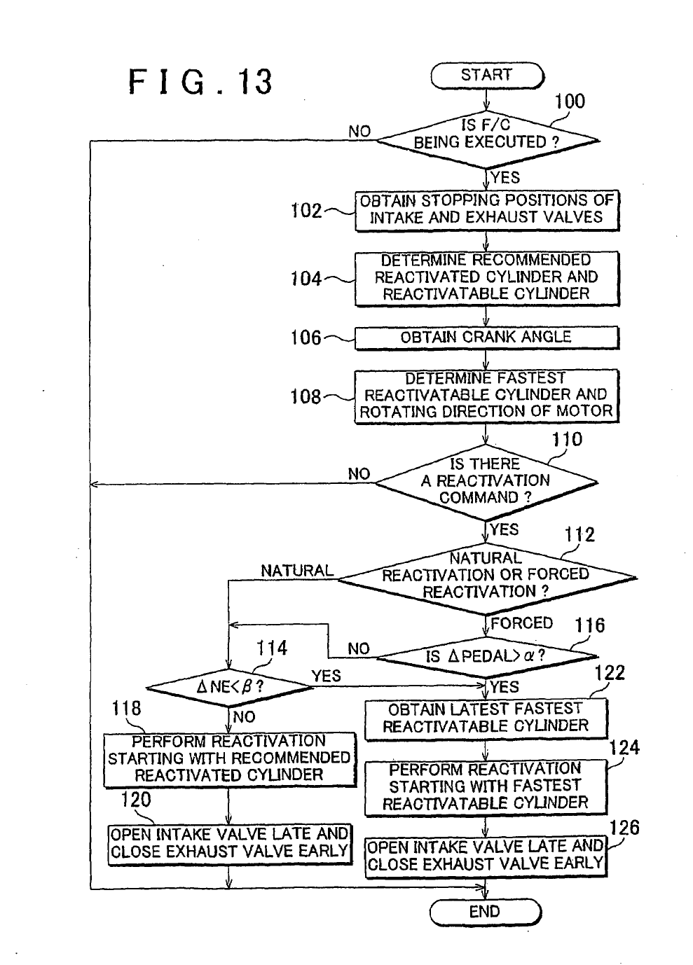

FIG. 13 is a flowchart of a routine executed by the ECU 40 in the example embodiment in order to realize the foregoing function. This routine is executed repeatedly in predetermined cycles such as a plurality of times within one rotation of the crankshaft 24.

According to the routine shown in FIG. 13, it is first determined whether a fuel cut is being executed (step 100). If a fuel cut is not being executed, then this cycle of the routine immediately ends. If a fuel cut is being executed, the stopping positions of the intake valves 32 and exhaust valves 36, i.e., the stopping positions of the intake camshafts 52 and 54 and the exhaust camshaft 76, are obtained (step 102). These stopping position can be obtained based on outputs from the cam angle sensors 84, 86, and 88, for example, or based on signals from the first motor 60, the second motor 68, and the motor 82.

Continuing on, the recommended reactivated cylinder (e.g., the #3 cylinder) is then determined from among the #1 to #4 cylinders based on the stopping position information of the intake camshafts 52 and 54 and the exhaust camshaft 76 obtained in step 102 (step 104). Moreover in step 104, the reactivatable cylinder when the first motor 60 and the second motor 68 are allowed to operate in reverse when driven again (e.g., the #4 cylinder) is also determined based on the foregoing stopping position information.

Next, the current crank angle is obtained based on the output from the crank angle sensor 42 (step 106), and the cylinder in which combustion can take place the fastest when resuming operation (hereinafter referred to as “fastest reactivatable cylinder”) is determined from among the recommended reactivated cylinder and the reactivatable cylinder based on the obtained current crank angle (step 108). For example, in the example shown in FIG. 12, if the current crank angle is in the range 90° CA before and after TDC of the #1 and #4 cylinders, and 90° CA before and after BDC of the #2 and #3 cylinders, the #3 cylinder is determined to be the fastest reactivatable cylinder. On the other hand, if the current crank angle is in the range 90° CA before and after BDC of the #1 and #4 cylinders, and 90° CA before and after TDC of the #2 and #3 cylinders, the #4 cylinder is selected as the fastest reactivatable cylinder.

Further, in step 108, the rotation direction when driving the first motor 60 and the second motor 68 again which corresponds to the determined fastest reactivatable cylinder is also determined. For example, in the example shown in FIG. 12, when the #3 cylinder is determined to be the fastest reactivatable cylinder, it is determined that the first motor 60 and the second motor 68 will both operate in the forward direction. On the other hand, when the #4 cylinder is determined to be the fastest reactivatable cylinder, it is determined that the first motor 60 will operate in the forward direction while the second motor 68 will operate in reverse.

Continuing on, it is then determined whether a reactivation command has been output (step 110). If a reactivation command has not been output, this cycle of the routine immediately ends. If a reactivation command has been output, however, then it is determined whether that reactivation command is based on natural reactivation or forced reactivation (step 112).

If it was determined in step 112 that the reactivation command is based on natural reactivation, it is then determined whether a change amount ΔNE in the engine speed NE per unit time is less than a predetermined determining value β (step 114). If the change amount ΔNE is determined to be equal to or greater than the determining value β, it means that the decrease in engine speed NE (i.e., deceleration) is small and there is no fear of engine stall so it can be determined that rapid reactivation is not necessary. In contrast, if the change amount ΔNE is smaller than the determining value β, it means that the decrease in engine speed NE (i.e., deceleration) is large so it is determined that the situation demands rapid reactivation in order to reliably avoid engine stall.

On the other hand, if it was determined in step 112 that the reactivation command is based on forced reactivation, it is then determined whether a depression amount in of the accelerator pedal per unit time (Δ pedal) is greater than a predetermined determining value α (step 116). If A pedal is determined to be equal to or less than the determining value α, it means that the depression rate of the accelerator pedal is slow and the degree of acceleration required by the driver is small so it can be determined that the situation does not demand rapid reactivation. In contrast, if Δ pedal is greater than the determining value α, it means that the depression rate of the accelerator pedal is fast and the degree of acceleration required by the driver is large so it can be determined that the situation demands rapid reactivation.

In this way, when the change amount ΔNE is equal to or greater than the determining value β in step 114 or Δ pedal is equal to or less than the determining value α in step 116, rapid reactivation is not necessary. Therefore, in these cases, the recommended reactivated cylinder determined in step 104 is ultimately determined to be the reactivated cylinder and operation is resumed started from the recommended reactivated cylinder (step 118). The process of resuming fuel injection and driving the valves again executed in step 118 is the same as the process illustrated in FIG. 10 described above so a description thereof will be omitted here. Also, when operation is resumed at this time, a process is executed which shortens the period of valve overlap by closing the exhaust valves 36 early and opening the intake valves 32 late, as described above (step 120).

On the other hand, when the change amount ΔNE is less than the determining value β in step 114 or Δ pedal is greater than the determining value α in step 116, rapid reactivation is necessary. Therefore, in these cases, information relating to the latest fastest reactivatable cylinder selected in step 108 is then obtained (step 122). This latest fastest reactivatable cylinder is determined to ultimately be the reactivated cylinder and operation is resumed starting from the current fastest reactivatable cylinder based on the rotation direction of the first motor 60 and the second motor 68 determined in step 108 (step 124). For example, when the #3 cylinder (i.e., the recommended reactivated cylinder) is the current fastest reactivatable cylinder, the process to resume fuel injection and drive the valves again shown in FIG. 10 is executed with the first motor 60 and the second motor 68 both starting to operate in the forward directions. In contrast, for example, when the #4 cylinder (i.e., the reactivatable cylinder) is the current fastest reactivatable cylinder, the process to resume fuel injection and drive the valves again shown in FIG. 11 is executed with the first motor 60 starting to operate in the forward direction and the second motor 68 starting to operate in reverse.

Even when operation is resumed starting from the fastest reactivatable cylinder, a process is executed which shortens the period of valve overlap by closing the exhaust valves 36 early and opening the intake valves 32 late, just like step 120 (step 126). The control which shortens the period of valve overlap by the process in step 120 or step 126 is cancelled when combustion stabilizes. The timing for this may be set as follows, for example. Typically, for a while after operation is resumed, control which changes the ignition timing with respect to a base ignition timing is executed to correct the torque. The control to shorten the period of valve overlap can be ended when this ignition timing control ends.

According to the routine shown in FIG. 13 described above, during a fuel cut the fastest reactivatable cylinder that continuously changes depending on the crank angle can be set in advance based on the crank angle before the reactivation command is output. Therefore, when rapid reactivation is necessary, the process to resume operation can be started from the fastest reactivatable cylinder immediately when a reactivation command is output. As a result, a delay in resuming operation can be better suppressed.

The foregoing example embodiment describes a control apparatus of a port injection type internal combustion engine in which fuel is injected into the intake port. The invention is not limited to this however, and may also be applied to a control apparatus of an in-cylinder direct injection type internal combustion engine in which fuel is injected directly into the cylinders.

Further, in the foregoing example embodiment, the motor 82 that drives the exhaust camshaft 76 always operates only in the forward direction, never in reverse. However, according to another example embodiment of the invention the motor 82 that drives the exhaust camshaft 76 may also rotate in reverse.

Also in the foregoing example embodiment, the fastest reactivatable cylinder is determined from among two cylinders. However, according to another example embodiment the fastest reactivatable cylinder may also be determined from among three or more cylinders.

In the foregoing example embodiment, the “fuel cutting means” in the first aspect is realized by the ECU 40 executing a fuel cut in the internal combustion engine 10. The “valve stopping means” in the first, twelfth, and thirteenth aspects is realized by the ECU 40 stopping the variable intake valve driving apparatus 34 and the variable exhaust valve driving apparatus 38 in the manner described based on FIGS. 7 to 9. The “reactivated cylinder determining means” in the first aspect is realized by the ECU 40 executing the processes in steps 102, 104, 112 to 118, 122, and 124. The “valve drive restarting means” in the first aspect is realized by the ECU 40 starting to drive the variable intake valve driving apparatus 34 and the variable exhaust valve driving apparatus 38 again in the manner described based on FIGS. 10 and 11, and the “fuel injection restarting means” in the first aspect is realized by the ECU 40 restarting fuel injection in the manner described based on FIGS. 10 and 11.

Also in the example embodiment described above, the first motor 60, the second motor 68, and the motor 82 correspond to the electric motors in the third and fourth aspects. Also, the “recommended reactivated cylinder determining means” in the second, third, and fourth aspects is realized by the ECU 40 determining the recommended reactivated cylinder in the process in step 104. The “reactivatable cylinder determining means” in the fourth aspect is realized by the ECU 40 determining the reactivatable cylinder in the process in step 104, and the “final determining means” in the fourth aspect is realized by the ECU 40 executing the processes in steps 112 to 118, 122, and 124.

Moreover, in the example embodiment described above, the “fastest reactivatable cylinder determining means” in the eighth and eleventh aspects is realized by the ECU 40 determining the fastest reactivatable cylinder in the processes in steps 106 and 108. The “rotating direction determining means” is realized by the ECU 40 determining the direction of rotation of the first motor 60 and the second motor 68 in the process in step 108. The “valve overlap shortening means” in the ninth aspect is realized by the ECU 40 executing the processes in steps 120 and 126, and the “means for setting the fastest reactivatable cylinder as the reactivated cylinder” in the eleventh aspect is realized by the ECU 40 executing the processes in steps 122 and 124.

### Modified Examples

In the example embodiment described above, the variable intake valve driving apparatus 34 and the variable exhaust valve driving apparatus 38 that directly drive the camshafts with motors are used as the apparatuses for driving the intake valves 32 and the exhaust valves 36. However, variable valve driving apparatuses that can be applied in the invention are not limited to the foregoing structures. For example, the variable valve driving apparatuses may also use electromagnetically driven valves which drive intake valves or exhaust valves using electromagnetic force.

Also in the foregoing example embodiment, the internal combustion engine described was an inline four cylinder internal combustion engine for the sake of convenience. However, the internal combustion engine to which the invention can be applied is not limited to that configuration.

While the invention has been described with reference to exemplary embodiments thereof, it is to be understood that the invention is not limited to the exemplary embodiments or constructions. To the contrary, the invention is intended to cover various modifications and equivalent arrangements. In addition, while the various elements of the exemplary embodiments are shown in various combinations and configurations, which are exemplary, other combinations and configurations, including more, less or only a single element, are also within the spirit and scope of the invention.

1. A control apparatus of an internal combustion engine, comprising:
a variable valve driving apparatus which selectively drives and stops an intake valve and an exhaust valve of the internal combustion engine which has a plurality of cylinders;
a fuel cut apparatus which performs a fuel cut in the internal combustion engine when a fuel cut executing condition is satisfied;
a valve stopping apparatus which stops the variable valve driving apparatus such that at least one of the intake valve and the exhaust valve in each cylinder remains closed during the fuel cut;
a reactivated cylinder determining apparatus which determines, based on at least one of a stopping position of the variable valve driving apparatus and a crank angle, a reactivated cylinder in which fuel injection is to be restarted first when resuming operation after a fuel cut;
a valve drive restarting apparatus which starts to drive the variable valve driving apparatus again when operation is resumed after a fuel cut such that burned gas remaining in the determined reactivated cylinder is discharged into an exhaust passage before the first intake stroke is performed in the reactivated cylinder after operation is resumed; and
a fuel injection restarting apparatus which restarts fuel injection in the reactivated cylinder such that fresh air that was drawn into the reactivated cylinder during the first intake stroke after the reactivated cylinder resumes operation can be combusted.

2. The control apparatus of an internal combustion engine according to claim 1, wherein the reactivated cylinder determining apparatus includes a recommended reactivated cylinder determining apparatus which determines a recommended reactivated cylinder based on the stopping position of the variable valve driving apparatus during the fuel cut.

3. The control apparatus of an internal combustion engine according to claim 1, wherein the variable valve driving apparatus is formed of an electromagnetically driven valve that drives the at least one of the intake valve and the exhaust valve.

4. The control apparatus of an internal combustion engine according to claim 1, wherein the variable valve driving apparatus has at least one electric motor that rotatably drives a camshaft, and the reactivated cylinder determining apparatus includes a recommended reactivated cylinder determining apparatus which determines, as a recommended reactivated cylinder, a cylinder in which an intake stroke is performed first based on the stopping position of the camshaft under the condition that the electric motor rotates only in the forward direction when the valves of the cylinders start to be driven again when operation resumes after a fuel cut.

5. The control apparatus of an internal combustion engine according to claim 1, wherein the variable valve driving apparatus has at least one electric motor that rotatably drives a camshaft, and the reactivated cylinder determining apparatus includes i) a recommended reactivated cylinder determining apparatus which determines, as a recommended reactivated cylinder, a cylinder in which an intake stroke is performed first based on the stopping position of the camshaft under the condition that the electric motor rotates only in the forward direction when the valves of the cylinders start to be driven again when operation resumes after a fuel cut, ii) a reactivatable cylinder determining apparatus which determines, as a reactivatable cylinder, a cylinder in which an intake stroke is performed first based on the stopping position of the camshaft when the electric motor is allowed to rotate in reverse when the valves in the cylinders start to be driven again when operation resumes after a fuel cut, and iii) a final determining apparatus which determines one cylinder, from among the recommended reactivated cylinder and the reactivatable cylinder, to be the reactivated cylinder.

6. The control apparatus of an internal combustion engine according to claim 5, wherein the final determining apparatus determines the reactivated cylinder giving priority to the recommended reactivated cylinder over the reactivatable cylinder.

7. The control apparatus of an internal combustion engine according to claim 6, wherein the final determining apparatus determines a cylinder in which combustion can be restarted first based on the crank angle, from among the recommended reactivated cylinder and the reactivatable cylinder, to be the reactivated cylinder in a predetermined situation in which operation should be resumed quickly after a fuel cut, and determines the recommended reactivated cylinder to be the reactivated cylinder regardless of the crank angle in a situation other than the predetermined situation.

8. The control apparatus of an internal combustion engine according to claim 7, wherein the predetermined situation includes at least one of a situation in which a decrease in engine speed is equal to or greater than a predetermined value in the case of natural reactivation which is brought about by the engine speed being equal to or less than a predetermined reactivation speed, and a situation in which the degree of acceleration required is equal to or greater than a predetermined value in the case of forced reactivation which is brought about by a request for acceleration being output.

9. The control apparatus of an internal combustion engine according to claim 5, further comprising:
a fastest reactivatable cylinder determining apparatus which determines a fastest reactivatable cylinder in which combustion can restart first based on the crank angle, from among the recommended reactivated cylinder and the reactivatable cylinder; and
a rotating direction determining apparatus which determines the direction of rotation when the motor starts to be driven again when operation resumes after a fuel cut with the fastest reactivatable cylinder as the reactivated cylinder.

10. The control apparatus of an internal combustion engine according to claim 1, further comprising:
a valve overlap shortening apparatus which shortens, compared to normal, a period of valve overlap during which the exhaust valve and the intake valve of the same cylinder are both open when operation resumes after a fuel cut.

11. The control apparatus of an internal combustion engine according to claim 10, wherein the valve overlap shortening apparatus eliminates the period of valve overlap.

12. The control apparatus of an internal combustion engine according to claim 10, wherein the valve overlap shortening apparatus cancels the shortening of the period of valve overlap when ignition timing control, which is executed to correct torque, ends after operation resumes after a fuel cut.

13. The control apparatus of an internal combustion engine according to claim 1, wherein the reactivated cylinder determining apparatus includes a fastest reactivatable cylinder determining apparatus which repeatedly determines the fastest reactivatable cylinder in which combustion can restart first based on the crank angle during one rotation of a crankshaft, as well as an apparatus which sets the cylinder that is determined by the fastest reactivatable cylinder determining apparatus at the time a reactivation command is output as the reactivated cylinder.

14. The control apparatus of an internal combustion engine according to claim 1, wherein during the fuel cut the valve stopping apparatus stops driving the variable valve driving apparatus such that the intake valve in each cylinder remains closed and no fresh air remains in any cylinders.

15. The control apparatus of the internal combustion engine according to claim 1, wherein during the fuel cut the valve stopping apparatus stops driving the variable valve driving apparatus such that, by having the intake valves remain closed and the exhaust valves remain open in at least a pair of cylinders having pistons which always travel in opposite directions, burned gas passes between the pair of cylinders through the exhaust passage.

16. The control apparatus of an internal combustion engine according to claim 15, wherein the cylinders in the pair change depending on the timing at which the fuel cut starts.

17. The control apparatus of an internal combustion engine according to claim 1, wherein the reactivated cylinder determining apparatus determines one cylinder, from among the cylinders in which the exhaust valve remains open during the fuel cut, to be the reactivated cylinder.

18. A control method of an internal combustion engine including a variable valve driving apparatus which selectively drives and stops an intake valve and an exhaust valve of the internal combustion engine which has a plurality of cylinders, fuel cutting apparatus which performs a fuel cut in the internal combustion engine when a fuel cut executing condition is satisfied, and valve stopping apparatus which stops the variable valve driving apparatus such that at least one of the intake valve and the exhaust valve in each cylinder remains closed during the fuel cut, comprising:
determining, based on at least one of a stopping position of the variable valve driving apparatus and a crank angle, a reactivated cylinder in which fuel injection is to be restarted first when operation resumes after a fuel cut;
starting to drive the variable valve driving apparatus again when operation is resumed after a fuel cut such that burned gas remaining in the determined reactivated cylinder is discharged into an exhaust passage before the first intake stroke is performed in the reactivated cylinder after operation is resumed; and
restarting fuel injection in the reactivated cylinder such that fresh air that was drawn into the reactivated cylinder during the first intake stroke after the reactivated cylinder resumes operation can be combusted.

19. The control method of an internal combustion engine according to claim 18, wherein a recommended reactivated cylinder is determined based on the stopping position of the variable valve driving apparatus during the fuel cut.

20. The control method of an internal combustion engine according to claim 18, wherein the variable valve driving apparatus has at least one electric motor that rotatably drives a camshaft, and a cylinder in which an intake stroke is performed first based on the stopping position of the camshaft under the condition that the electric motor rotates only in the forward direction when the valves of the cylinders start to be driven again when operation resumes after a fuel cut, is determined to be a recommended reactivated cylinder.

21. The control method of an internal combustion engine according to claim 18, wherein the variable valve driving apparatus has at least one electric motor that rotatably drives a camshaft; a cylinder in which an intake stroke is performed first based on the stopping position of the camshaft under the condition that the electric motor rotates only in the forward direction when the valves of the cylinders start to be driven again when operation resumes after a fuel cut is determined to be a recommended reactivated cylinder; a cylinder in which an intake stroke is performed first based on the stopping position of the camshaft when the electric motor is allowed to rotate in reverse when the valves in the cylinders start to be driven again when operation resumes after a fuel cut is determined to be a reactivatable cylinder; and one cylinder, from among the recommended reactivated cylinder and the reactivatable cylinder, is determined to be the reactivated cylinder.

22. The control method of an internal combustion engine according to claim 21, wherein the reactivated cylinder is determined giving priority to the recommended reactivated cylinder over the reactivatable cylinder.

23. The control method of an internal combustion engine according to claim 22, wherein a cylinder in which combustion can be restarted first based on the crank angle, from among the recommended reactivated cylinder and the reactivatable cylinder, is determined to be the reactivated cylinder in a predetermined situation in which operation should be resumed quickly after a fuel cut, and the recommended reactivated cylinder is determined to be the reactivated cylinder regardless of the crank angle in a situation other than the predetermined situation.

24. The control method of an internal combustion engine according to claim 23, wherein the predetermined situation includes at least one of a situation in which a decrease in engine speed is equal to or greater than a predetermined value in the case of natural reactivation which is brought about by the engine speed being equal to or less than a predetermined reactivation speed, and a situation in which the degree of acceleration required is equal to or greater than a predetermined value in the case of forced reactivation which is brought about by a request for acceleration being output.

25. The control method of an internal combustion engine according to claim 21, further comprising:
determining a fastest reactivatable cylinder in which combustion can restart first based on the crank angle, from among the recommended reactivated cylinder and the reactivatable cylinder; and
determining the direction of rotation when the motor starts to be driven again when operation resumes after a fuel cut with the fastest reactivatable cylinder as the reactivated cylinder.

26. The control method of an internal combustion engine according to claim 18, further comprising:
shortening, compared to normal, a period of valve overlap during which the exhaust valve and the intake valve of the same cylinder are both open when operation resumes after a fuel cut.

27. The control method of an internal combustion engine according to claim 26, wherein the period of valve overlap is eliminated.

28. The control method of an internal combustion engine according to claim 26, wherein the shortening of the period of valve overlap is cancelled when ignition timing control, which is executed to correct torque, ends after operation resumes after a fuel cut.

29. The control method of an internal combustion engine according to claim 18, wherein the fastest reactivatable cylinder in which combustion can restart first based on the crank angle during one rotation of a crankshaft is repeatedly determined, and the cylinder that is determined to be the fastest reactivatable cylinder at the time a reactivation command is output is set as the reactivated cylinder.

30. The control method of an internal combustion engine according to any claim 18, wherein during the fuel cut the variable valve driving apparatus stops being driven such that the intake valve in each cylinder remains closed and no fresh air remains in any cylinders.

31. The control method of the internal combustion engine according to claim 18, wherein during the fuel cut the variable valve driving apparatus stops being driven such that, by having the intake valves remain closed and the exhaust valves remain open in at least a pair of cylinders having pistons which always travel in opposite directions, burned gas passes between the pair of cylinders through the exhaust passage.

32. The control method of an internal combustion engine according to claim 31, wherein the cylinders in the pair change depending on the timing at which the fuel cut starts.

33. The control method of an internal combustion engine according to claim 18, wherein one cylinder, from among the cylinders in which the exhaust valve remains open during the fuel cut, is determined to be the reactivated cylinder.

34. (canceled)
